(19) United States
(12) Patent Application Publication
(10) Pub. No.: US 2026/0204041 A1
(43) Pub. Date: Jul. 16, 2026

(54) METHOD AND APPARATUS FOR DETERMINING IMAGE AND TRAINING MODEL, DEVICE, MEDIUM AND PROGRAM PRODUCT

(71) Applicant: Beijing Co Wheels Technology Co., Ltd., Beijing (CN)

(72) Inventors: Yang WANG, Beijing (CN); Kun Zhan, Beijing (CN); Tao Tang, Beijing (CN); Dafeng Wei, Beijing (CN); Zhengyu Jia, Beijing (CN); Tian Gao, Beijing (CN)

(21) Appl. No.: 19/077,088

(22) Filed: Mar. 12, 2025

(30) Foreign Application Priority Data
Jan. 10, 2025 (CN) 202510045685.X

(51) Int. Cl. G06V 10/44; G06F 16/583; G06F 40/263

(52) U.S. Cl. CPC G06V 10/443; G06F 16/5846; G06F 40/263

(57) ABSTRACT

The present application provides a method and an apparatus for determining an image, a method and an apparatus for training a model, a device, a medium and a program product. The method includes the following operations. The first language feature is extracted from a retrieval text. A matching result between the first language feature and a Birds Eyes feature set corresponding to an image set is determined. A target image is determined from the image set based on the matching result.

### CROSS-REFERENCE TO RELATED APPLICATIONS

This application is filed based on and claims priority to Chinese patent application No. 202510045685.X filed on Jan. 10, 2025, the disclosure of which is hereby incorporated by reference in its entirety.

### BACKGROUND

In practical applications, the retrieval technology for local planar images has been successfully applied to many scenes. However, local planar images cannot carry the global features of diversified environments including complex traffic environments. Therefore, the demand for image retrieval in diversified scenes including complex traffic environments cannot be satisfied by the retrieval technology for local planar images in related art.

### SUMMARY

The present application relates to technology for image processing, and in particular to, a method and apparatus for determining an image and training a model, a device, a medium, and a program product.

Based on the above technical problems, embodiments of the present disclosure provide a method and apparatus for determining an image and training a model, a device, a medium, and a program product.

The technical solutions of the embodiments of the present disclosure are implemented as follows.

Embodiments of the present disclosure firstly provide a method for determining an image. The method includes the following operations.

The first language feature is extracted from a retrieval text.

A matching result between the first language feature and a Birds Eyes feature set corresponding to an image set is determined.

A target image is determined from the image set based on the matching result.

The embodiments of the present disclosure further provide a method for training a model. The method includes the following operation.

An initial retrieval model is trained based on sample data to obtain a retrieval model. The retrieval model is used to determine a matching result between the first language feature and a Birds Eyes feature set corresponding to an image set. The first language feature is extracted from the retrieval text. The matching result is used to determine a target image from the image set.

The embodiments of the present disclosure further provide an apparatus for determining an image. The apparatus for determining an image includes a processor and a memory, the memory is configured to store a computer program that, when being executed by the processor, causes the apparatus to: extract the first language feature from a retrieval text, and determine a matching result between the first language feature and a Bird Eyes feature set corresponding to an image set, and determine a target image from the image set based on the matching result.

The embodiments of the present disclosure further provide an apparatus for training a model. The apparatus for training a model includes a processor and a memory, the memory is configured to store a computer program that, when being executed by the processor, causes the apparatus to perform the above method for training a model. The method includes the following operation.

An initial retrieval model is trained based on sample data to obtain a retrieval model. The retrieval model is used to determine a matching result between the first language feature and a Birds Eyes feature set corresponding to an image set. The first language feature is extracted from the retrieval text. The matching result is used to determine a target image from the image set.

The embodiments of the present disclosure further provide a computer readable storage medium. The storage medium stores a computer program. When the computer program is executed by the processor of the electronic device, the above method for determining a model or the above method for training a model is implemented.

The embodiments of the present disclosure further provide a computer program product. The program product includes a computer program. When the computer program is executed by the processor of the electronic device, the above method for determining a model or the above method for training a model is implemented.

### BRIEF DESCRIPTION OF THE DRAWINGS

FIG. 1 is a schematic diagram of comparison of effects of image retrieval.

FIG. 2 is a schematic flowchart of a method for determining an image according to an embodiment of the present disclosure.

FIG. 3A is a schematic diagram of a structure of a Knowledge Graph (KG) according to an embodiment of the present disclosure.

FIG. 3B is a schematic flowchart of obtaining the first language feature according to an embodiment of the present disclosure.

FIG. 3C is a schematic diagram of a structure of a retrieval model according to an embodiment of the present disclosure.

FIG. 4 is a schematic flowchart of a method for training a model according to an embodiment of the present disclosure.

FIG. 5A is a schematic diagram of comparison of effects of sample descriptions at different levels according to an embodiment of the present disclosure.

FIG. 5B is a schematic diagram of comparison of effects of retrieving two-dimensional images according to an embodiment of the present disclosure.

FIG. 6 is a schematic structural diagram of an apparatus for determining an image according to an embodiment of the present disclosure.

FIG. 7 is a schematic structural diagram of an apparatus for training a model according to an embodiment of the present disclosure.

FIG. 8 is a schematic structural diagram of an electronic device according to an embodiment of the present disclosure.

It should be pointed out that the above “first” and “second” are only used to distinguish different solutions, and do not mean that they are used to distinguish the advantages and disadvantages of solutions or the priorities in the implementation process.

### DETAILED DESCRIPTION

In order to make the object, technical solutions and advantages of the present disclosure more clear, the present disclosure will be described in further detail below with reference to the accompanying drawings, and the described embodiments should not be regarded as limiting the present disclosure, and all other embodiments obtained by those skilled in the art without creative work belong to the scope of protection of the present disclosure.

In the following description, reference is made to “some embodiments”, which describes subsets of all possible embodiments, but it will be understood that “some embodiments” may be the same subset or different subsets of all possible embodiments, which may be combined with each other without conflict.

In the following description, reference to the terms “first\second” is merely intended to distinguish similar objects, and does not represent a specific ordering for objects, and it is understood that “first\second” may be interchanged for a specific order or priority order where permitted to enable the embodiments of the present disclosure described herein to be implemented in an order other than that illustrated or described herein.

In the embodiments of the present disclosure, the term “module” or “unit” refers to a computer program or a part of a computer program having a predetermined function and working together with other relevant parts to achieve a predetermined object, and may be achieved in whole or in part by using software, hardware (such as processing circuitry or memory), or a combination thereof. Likewise, a processor (or processors or memories) may be used to implement one or more modules or units. Furthermore, each module or unit may be part of an overall module or unit that contains the function of the module or unit.

Unless otherwise defined, all technical and scientific terms used in the embodiments of the present disclosure have the same meanings as commonly understood by those skilled in the art. The terminology used in the embodiments of the present disclosure is for the purpose of describing the embodiments of the present disclosure only, and is not intended to limit the present disclosure.

When the relevant data collection and processing in the embodiments of the present disclosure is applied in the example, the informed consent or individual consent of the personal information subject should be obtained in strict accordance with the requirements of relevant national laws and regulations, and subsequent data usage and processing should be carried out within the scope of authorization of the laws and regulations and the personal information subject.

Before further describing the embodiments of the present disclosure in detail, the phrases and terms related to the embodiments of the present disclosure will be described, and the phrases and terms related to the embodiments of the present disclosure are applicable to the following explanations.

1) Birds Eyes View (BEV): A BEV has been developed rapidly in the field of autonomous driving. The locations and semantic information of objects in a planar environment can be accurately obtained through this technology. This technology is particularly important for tasks such as object detection and map semantic segmentation. The BEV map integrates data from different sensors into a consistent format that coincides with the planar geometry structure of the scene, thus enhancing the two-dimensional projection effect.

2) Large Language Model (LLM): It refers to a deep learning model trained by using a large amount of text data, and it can generate natural language text or understand the meaning of language text. The LLM can handle a variety of natural language tasks, such as text classification, question and answer, and dialogue, and it is an important way to artificial intelligence.

3) Knowledge Graph (KG): It is called knowledge domain visualization or knowledge domain mapping map, it is a series of different graphs that show the development process of knowledge and the structural relation. It uses visualization technology to describe knowledge resources and their carriers, mines, analyzes, constructs, draws and displays knowledge and their interconnections.

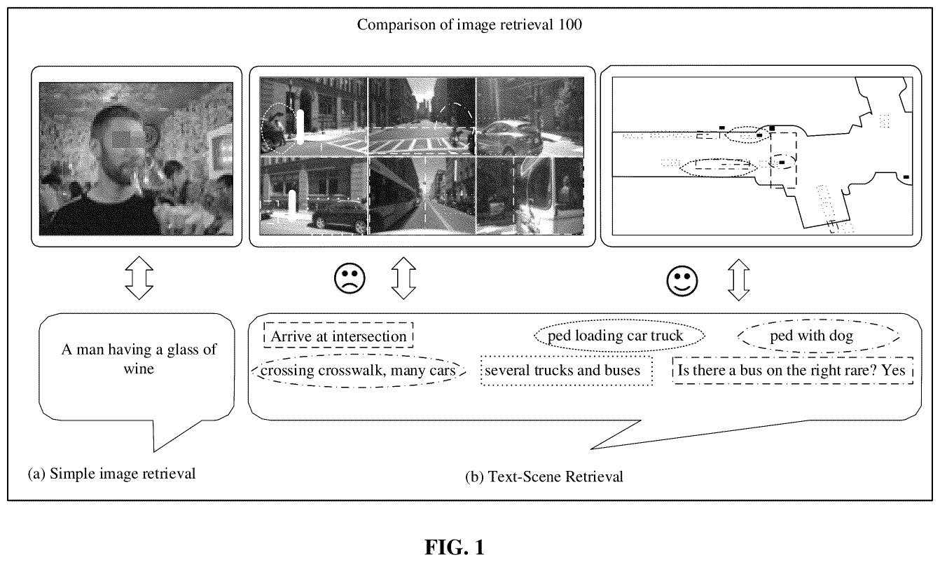

With the boom of language and visual depth models, cross-modal Image-Text Retrieval (ITR) presents a significant advancement over the past few years, and good retrieval results can be obtained through the ITR when handling simple retrieval tasks. FIG. 1 is a schematic diagram of comparison of effects of image retrieval. As illustrated in FIG. 1, a man having a glass of wine as illustrated in FIG. 1 may be retrieved by ITR based on the input text of “a man having a glass of wine”. Similarly, when the input text is “a brown dog” or in a slightly complicated form, a good image retrieval result can be obtained by ITR. However, ITR cannot cope with the retrieval task of complex traffic environments in extremely challenging autonomous driving scenes.

On the other hand, thanks to the data collection function of vehicles, crowdsourcing vehicles and the rapid development of the autonomous driving industry, the data in autonomous driving scenes has also been transitioned from the scarce stage to the abundant stage. However, evenly distributed data cannot satisfy the demand for autonomous driving scene optimization. For example, if the goal of autonomous driving scene optimization is to improve the autonomous driving performance of vehicles on rural roads, enough rural road data must be retrieved to fine-tune the autonomous driving control model. Therefore, data mining has been become the basic working framework for providing specialized optimization of autonomous driving models, and a well-designed retrieval method plays a vital role in the closed-loop data-driven process of autonomous driving data.

All in all, for autonomous driving scenes, the demand for image retrieval that is professional and high-precision, and can carry global environmental features is growing. However, the image retrieved by the method for image retrieval in the related art lacks the global feature representation, so the above method has insufficient text retrieval ability for complex driving scenes. For example, as illustrated in FIG. 1, when the input text is “arrive at intersection, ped loading car truck, ped with dog, crossing crosswalk, many cars, several trucks and buses, is there a bus on the right? Yes”, the complex traffic scene described in the input texts proposes a huge challenge for the retrieval model used in the autonomous driving scene to fully understand the global context of the traffic scene, as well as the complex and long text. These demands are beyond the data processing abilities of the above retrieval model. Therefore, the set of a series of two-dimensional images illustrated in the middle of FIG. 1 may be obtained by the method for image retrieval in the related art, but obviously, the current driving scene of the vehicle cannot be represented through the set of these images.

In order to solve the above technical problems, the embodiments of the present disclosure provide a method for determining an image. According to the method for determining an image provided by the embodiments of the present disclosure, when the retrieval is performed based on the retrieval text “arrive at intersection, ped loading car truck, ped with dog, crossing crosswalk, many cars, several trucks and buses, is there a bus on the right rare? Yes”, a Birds Eyes image carrying global three-dimensional features illustrated on the rightmost side of FIG. 1 may be obtained, so as to satisfy the demand for retrieving images in diversified scenes including complex traffic environments.

FIG. 2 is a schematic flowchart of a method for determining an image according to an embodiment of the present disclosure. As illustrated in FIG. 2, the method may be implemented by the following operations.

In operation S201, the first language feature is extracted from a retrieval text.

In an embodiment, the retrieval text may be set in advance or input by a user, and the retrieval text includes descriptive data for multiple dimensions of at least one scene object. Exemplarily, the scene object may include an object having vital characteristic, such as a pedestrian and a pet. Exemplarily, the scene object may include an object that does not have vital characteristic, such as a vehicle, a traffic light, a crosswalk, lane dividing lines, and the like.

In an embodiment, the retrieval text may include descriptive data of at least one of: a number, an action, a pose, a size, or a relative positional relation of the at least one scene object.

In an embodiment, the feature in the first language feature may be contextually associated, and the first language feature includes a status feature of at least one scene object. Exemplarily, the status feature may include a feature corresponding to at least one of: a color, a shape, a position, a size, a pose, or an action of the at least one scene object.

In an embodiment, the first language feature may include a set of spatial dimension and/or temporal dimension features, and context-associated features of at least one scene object.

In an embodiment, the first language feature may be extracted by the following manner.

The association status between scene objects in the retrieval text is analyzed through the LLM to obtain a status analysis result, then feature extraction is performed on the retrieval text to obtain a feature extraction result, and then integration is performed on the features in the feature extraction result according to the status analysis result, and a set of features obtained by integration is determined as the first language feature. The status analysis result may include whether the scene objects are associated with each other, the closeness degree of the association, and the like.

In operation S202, a matching result between the first language feature and a Birds Eyes feature set corresponding to an image set is determined.

In an embodiment, the image set may be built in advance or may be continuously expanded according to the actual demand for image retrieval. Exemplarily, the image set may include multiple panoramic top view images, and the panoramic top view images may carry global three-dimensional spatial features corresponding to multiple scenes. The multiple scenes may include at least one of scenes described above, and the three-dimensional spatial features may include features of multiple kinds of scene objects and/or multiple scene objects that may exist in the multiple scenes in the three-dimensional stereoscopic space.

In an embodiment, the panoramic top view images in the image set may include a BEV image and/or a Birds Eyes image. The BEV image may be obtained by integrating multiple planar images and/or depth images, the Birds Eyes image may include a top-view image obtained by an image acquisition device set at a high-altitude position in a birds eyes attitude, and the Birds Eyes image may be a depth image.

In an embodiment, the Birds Eyes feature set may be obtained by the following manner.

The Birds Eyes feature set is obtained by performing global feature extraction on images in the image set through a neural network with image feature extraction function. That is, the Birds Eyes features in the Birds Eyes feature set may include global, spatial and/or temporal features carried by images in the image set.

In an embodiment, the matching result may include whether the first language feature matches the features in the Birds Eyes feature set, the degree of matching, and the like.

In an embodiment, the matching result may be determined by the following manner.

A matrix similarity calculation is performed between the language feature matrix corresponding to the first language feature and the n-th Birds Eyes matrix corresponding to the n-th feature in the Birds Eye feature set, and the matrix similarity obtained by calculating is determined as the matching result. Herein, n may be an integer greater than or equal to 1.

In operation S203, a target image is determined from the image set based on the matching result.

In an embodiment, the target image may include at least one panoramic top view image, or the target image may include a set of multiple plane images or multiple depth images corresponding to the BEV image.

In an embodiment, the target image may be obtained by any of the following manners.

If the matching result includes multiple matching degrees, a panoramic top view image, corresponding to a maximum matching degree among the multiple matching degrees, in the image set is determined as the target image. If the matching result includes one matching degree, and the matching degree is greater than the degree threshold, the image corresponding to the matching degree in the image set may be determined as the target image.

As can be seen from the above, in the method for determining an image provided by the embodiments of the present disclosure, the first language feature is extracted from the retrieval text, and a matching result between the first language feature and the Birds Eyes feature set corresponding to the image set is determined, so that traversal matching for the Birds Eyes feature set corresponding to the image set is implemented based on the first language feature corresponding to the retrieval text. Further, the matching degree between the image in the image set and the retrieval text corresponding to the first language feature can be intuitively and accurately represented through the matching result. On this basis, a target image is determined from the image set based on the matching result, thereby improving the association between the target image and the retrieval text, and realizing targeted search and screening of images in the image set. On the other hand, since the matching result is determined based on the first language feature and the Birds Eyes feature set corresponding to the image set, when the retrieval text and the image set correspond to the diversified complex scenes, the demand for screening and retrieving the image set corresponding to the diversified complex scene can be satisfied by the technical solutions provided by the present disclosure. When the technical solutions provided by the embodiments of the present disclosure are applied to an autonomous driving scene, if the retrieval text corresponds to the autonomous driving scene, and the image set corresponds to the BEV images in the complex traffic scene, accurate and flexible retrieval for the BEV image corresponding to the complex traffic scene can be implemented based on the complex descriptive data corresponding to the autonomous driving scene, and thus the demand for image retrieval in diversified scenes including the complex traffic environment can be satisfied.

Based on the foregoing embodiment, in the method for determining an image provided by the embodiments of the present disclosure, the operation of extracting the first language feature from the retrieval text may be implemented by the following operations.

In operation SA1, feature extraction processing is performed on the retrieval text to obtain the first text feature.

The retrieval text includes descriptive data for multiple dimensions of the target scene.

In an embodiment, the target scene may include a scene having a complexity degree greater than or equal to the first threshold and a diversification degree greater than or equal to the second threshold. Exemplarily, the target scene may include a complex traffic scene, for example, the target scene may include an autonomous driving scene in a traffic congestion status.

In an embodiment, the first text feature may include a vector representation of the retrieval text. Accordingly, the first text feature may be obtained by the following manner.

The feature extraction processing is performed on the retrieval text through the text feature extraction model to obtain the first text feature.

In operation SA2, the second text feature corresponding to the target scene is determined based on a KG.

The KG is at least associated with the target scene.

In an embodiment, association between the KG and the target scene may include at least one of: the KG including scene objects that may appear in the target scene, the KG including actions that may be performed by the respective scene objects or status of the respective scene objects, or the KG including relative relations between the respective scene objects.

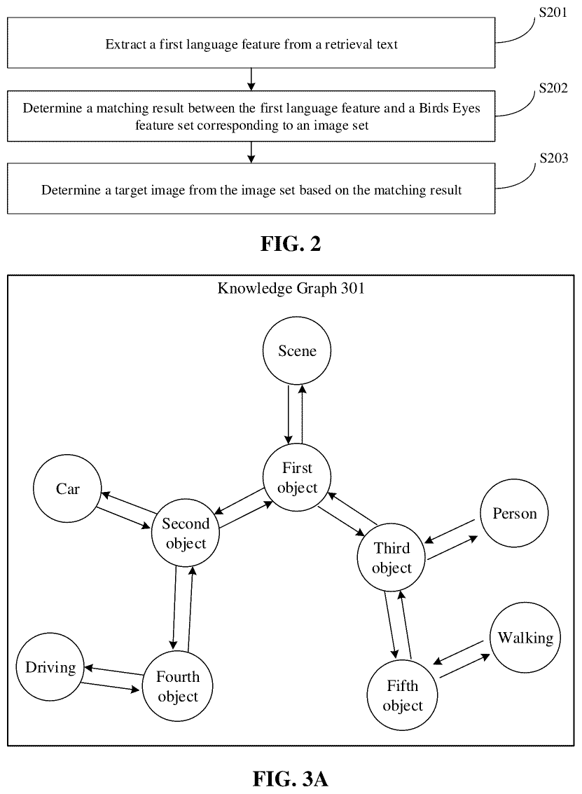

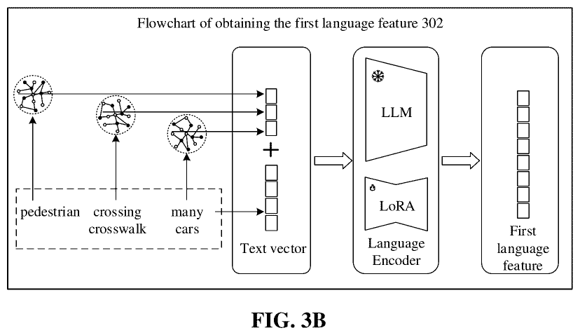

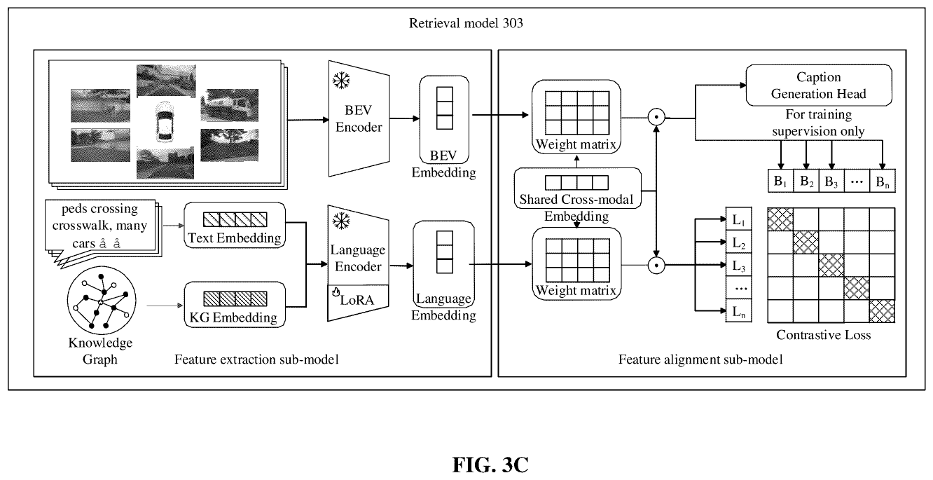

FIG. 3A is a schematic diagram of a structure of a KG according to an embodiment of the present disclosure. Exemplarily, the KG 301 may correspond to a complex traffic environment in an autonomous driving scene.

Exemplarily, the KG 301 may include five scene objects, i.e., the first object to the fifth object, and the five scene objects are respectively associated with object status such as a scene, a car, a person, driving, and walking.

In practical applications, the KG is a type of multi-relational graph that stores factual knowledge in the real world. It is typically represented as G={E, R, S}. Here, E denotes the set of entities, R denotes the set of relations, and S represents the relational facts. Facts observed in G are stored as a collection of triples: G={(h, r, t)}. Each triple consists of a head entity h∈E, a tail entity t∈E, and a relation r∈R between them, e.g., G may be <scene, includes, car>.

In an embodiment of the present application, the KG may be obtained by constructing scene objects in the autonomous driving scene and the interrelations between the scene objects in the autonomous driving scene. Each node in the KG corresponds to a keyword related to the autonomous driving scene, and the embeddings related to these nodes capture the associative representation of the autonomous driving keywords.

Moreover, the KG may be obtained by simplifying the large-scale data and complicated graph structure included in the original KG in the field of autonomous driving. Exemplarily, through the KG, entities in the autonomous driving field and relations between the entities in the autonomous driving field may be represented in a low-dimensional vector space while also maintaining the semantics contained in the original KG. Exemplarily, a semantic transitional distance-based modeling method may be adopted to construct the KG. Specifically, a distance-based scoring function as shown in Equation (1) may be adopted to optimize the embeddings.

$${f}_{r} ( h , t ) = - {‖ h + r - t ‖}_{p} \qquad ( 1 )$$

Here, p=1 or p=2, h, t, and r represent the embedding of head entity, tail entity, and the relation between entities, respectively. r represents a translation vector from h to t. When the triple (h, r, t) holds true, with the above scoring function, the relationships described by the triples within the autonomous driving scene may be captured from the original KG.

In an embodiment, the second text feature may correspond to the graph data. The graph data may include descriptive data, of the interrelation between at least one scene object or the object status, included in the KG. Accordingly, the second text feature may be denoted as KG Embedding.

In an embodiment, the second text feature may be obtained by the following manner.

Objects in the KG are screened and filtered based on at least one scene object to obtain the first data, then data, associated with the first data and used for representing actions, behaviors, positions and poses, in the KG, is determined as the second data. The set of the first data and second data is determined as the graph data, and then feature extraction is performed on the graph data to obtain the second text feature.

In operation SA3, the first text feature and the second text feature are integrated to obtain the first language feature.

In an embodiment, language feature extraction may be performed on the first text feature and the second text feature, thereby obtaining the first language feature.

FIG. 3B is a schematic flowchart of obtaining the first language feature according to an embodiment of the present disclosure. As illustrated in FIG. 3B, the operations of obtaining the first language feature may include the following operations. The text “pedestrians, crossing crosswalk, many cars” is input to the text feature extraction module to obtain the first text feature. At the same time, the above text is processed through the KG to obtain a text processing result, and then the text processing result is input to the text feature extraction module to obtain the second text feature. The text vector may include the first text feature and the second text feature. Then, the first text feature and the second text feature are concatenated to obtain a text feature concatenated result, and the text feature concatenated result is inputted to a language encoder including the LLM and the LoRA to obtain the first language feature.

Exemplarily, the first text feature and the second text feature may be concatenated according to the appearance order of the data in the text processing result and the appearance order of the data in the retrieval text.

Through the above operations, the KG may be embedded into the retrieval text. Since the data carried in the KG may include autonomous driving knowledge and scene descriptive data, each object node in the KG corresponds to a keyword related to autonomous driving. Thus, through the above operations, the data and status related to the autonomous driving scene are accurately captured, and the first text feature carried by the retrieval text is further expanded and enriched.

As can be seen from the above, in the method for determining an image provided by the embodiments of the present disclosure, feature extraction processing is performed on a retrieval text to obtain the first text feature, and the retrieval text includes descriptive data for multiple dimensions of the target scene, so that discretized text features of the target scene included in the retrieval text can be obtained by the above operations. Further, the second text feature corresponding to the target scene is determined based on the KG, and the KG is at least associated with the target scene, thereby improving the association degree between the second text feature, and the KG and target scene. In addition, with the help of the diversification and comprehensiveness of the data carried in the KG, the diversification and comprehensiveness of the features in the second text feature may be improved. On this basis, the first text feature and the second text feature are integrated to obtain the first language feature, thereby improving the comprehensiveness and accuracy of the first language feature.

Based on the foregoing embodiment, in the method for determining an image provided by the embodiments of the present disclosure, the operation of determining the second text feature corresponding to the target scene based on the KG may be implemented by the following operations.

In operation SC1, the target scene is analyzed based on the KG to determine an object parameter set.

The object parameter set includes a status parameter of at least one scene object in the target scene.

In an embodiment, the object parameter set may include parameters, of status descriptions such as behavior, position, shape, size, and pose associated with at least one scene object, included in the KG.

In an embodiment, the object parameter set may be determined by the following manner.

The objects in the KG are screened based on an object identifier of at least one scene object to obtain an object screening result, and descriptive parameters including objects, actions or status associated with the object screening result in the KG are integrated to obtain the object parameter set. The object identifier may include a serial number and/or a name, and the like of the scene object.

In operation SC2, feature extraction processing is performed on a parameter in the object parameter set to obtain the second text feature.

In an embodiment, the feature extraction on the parameter in the object parameter set may be performed through the feature extraction module to obtain the second text feature.

As can be seen from the above, in the method for determining an image provided by the embodiments of the present disclosure, the target scene is analyzed based on the KG to determine an object parameter set, and the object parameter set includes a status parameter of at least one scene object in the target scene, thus, the comprehensiveness of the parameters in the object parameter set can be improved by the above method. Furthermore, feature extraction processing is performed on the parameters in the object parameter set to obtain the second text feature, thereby improving the comprehensiveness of the status features of the scene objects in the second text feature.

Based on the foregoing embodiment, in the method for determining an image provided by the embodiments of the present disclosure, the operation of determining the matching result between the first language feature and the Birds Eyes feature set corresponding to the image set may be implemented by the following operations.

In operation SE1, feature extraction processing is performed on an image in the image set to obtain the first Birds Eyes feature.

The Birds Eyes feature set includes the first Birds Eyes feature.

In an embodiment, the first Birds Eyes feature may be obtained by any of the following manners.

If the panoramic top view image is a BEV image in a complex traffic environment associated with the autonomous driving scene, the panoramic top view image is encoded by the BEV encoder to obtain the first Birds Eyes feature. In this case, the first Birds Eyes feature may include a BEV feature.

If the panoramic top view image is a Birds Eyes image instead of a BEV image, feature extraction processing is performed in advance on the Birds Eyes image through the feature extraction module to obtain the first Birds Eyes feature.

In operation SE2, alignment processing is performed between the first Birds Eyes feature and the first language feature.

In an embodiment, the alignment processing may be implemented by any of the following manners.

In the temporal dimension and/or the spatial dimension, the alignment processing is performed between the features in the first Birds Eyes feature and the features in the first language feature.

In the scene object dimension or the feature space dimension, the alignment processing is performed between the features in the first Birds Eyes feature and the features in the first language feature, so that the m-th feature of the i-th scene object in the first Birds Eyes feature may be aligned with the m-th feature of the i-th scene function object in the first language feature. Here, i and m are both integers greater than or equal to 1.

Since the first Birds Eye feature and the first language feature are in different feature spaces, the first Birds Eyes feature and the first language feature may be bridged by a set of shared learnable embeddings with a Shared Cross-modal Embedding function, to weaken the difference between the two types of features.

In operation SE3, the first Birds Eyes feature after the alignment and the first language feature after the alignment are matched to obtain the matching result.

In an embodiment, the matching result may be reflected by the similarity between the first Birds Eyes feature after the alignment and the first language feature after the alignment. Exemplarily, the above similarity may include a cosine similarity. Exemplarily, at least part of the panoramic top view images in the image set may be screened based on cosine similarity, and at least one panoramic top view image having a cosine similarity greater than or equal to a similarity threshold may be determined as a target image.

As can be seen from the above, in the method for determining an image provided by the embodiments of the present disclosure, feature extraction processing is performed on the image in the image set to obtain the first Birds Eyes feature, and then alignment processing is performed between the first Birds Eyes feature and the first language feature, so that the dimensional difference between the first Birds Eyes feature and the first language feature in different feature spaces can be reduced by the above operations, thereby providing data support for determining the matching result between the first Birds Eyes feature after the alignment and the first language feature after the alignment, and improving the accuracy of the matching result between the first Birds Eyes feature after the alignment and the first language feature after the alignment.

Based on the foregoing embodiment, in the method for determining an image provided by the embodiments of the present disclosure, the operation of determining the matching result between the first language feature and the Birds Eyes feature set corresponding to the image set may be realized in the following manner.

The first language feature and the Birds Eyes feature set are processed through at least a part of modules in a retrieval model, to determine the matching result.

The retrieval model includes the first extraction module, the second extraction module, a feature alignment module and a feature matching module. The first extraction module is configured to process the retrieval text to obtain the first language feature. The second extraction module is configured to perform feature extraction on an image in the image set to obtain the first Birds Eyes feature. The feature alignment module is configured to align the first Birds Eyes feature and the first language feature. The feature matching module is configured to match the first Birds Eyes feature after the alignment and the first language feature after the alignment to obtain the matching result. The Birds Eyes feature set includes the first Birds Eyes feature.

FIG. 3C is a schematic diagram of a structure of a retrieval model according to an embodiment of the present disclosure. As illustrated in FIG. 3C, the retrieval model 303 may include two parts: a feature extraction sub-model and a feature alignment sub-model. The feature extraction sub-model may include a BEV Encoder, and a Language Encoder associated with LoRA. The BEV Encoder is used to process multiple two-dimensional images to obtain a BEV feature, that is, the first Birds Eyes feature. The Language Encoder associated with LoRA is used to obtain the first language feature by the method provided in the foregoing embodiment. The Language Encoder may be an LLM.

Exemplarily, the feature alignment module may be a Shared Crossing modal Embedding (SCE), which is used to perform feature alignment processing between the first vector matrix corresponding to the first Birds Eyes feature and the second vector matrix corresponding to the first language feature, to obtain the first vector matrix after the alignment and the second vector matrix after the alignment.

Exemplarily, the panoramic top view image in the image set may be screened through the cosine similarity between the first vector matrix after the alignment and the second vector matrix after the alignment, to obtain the target image.

In an embodiment, the retrieval model may be referred to as a BEV-Text-Scene Retrieval (BEV-TSR) model because the retrieval model performs processing on the BEV image and the retrieval text.

From the above, it may be seen that in the method for determining an image according to the embodiments of the present disclosure, the first language feature and the Birds Eyes feature set are processed through at least a part of modules in the retrieval model, to determine the matching result, and the retrieval model includes the first extraction module, the second extraction module, the feature alignment module and the feature matching module. The first extraction module is configured to process the retrieval text to obtain the first language feature, the second extraction module is configured to perform feature extraction on an image in the image set to obtain the first Birds Eyes feature, the feature alignment module is configured to align the first Birds Eyes feature and the first language feature, the feature matching module is configured to match the first Birds Eyes feature after the alignment and the first language feature after the alignment. In this way, the integrated processing for the retrieval text and the image set can be realized through the above respective modules, and the accuracy of the target image can be improved by the processing operations of the feature alignment module and the feature matching module.

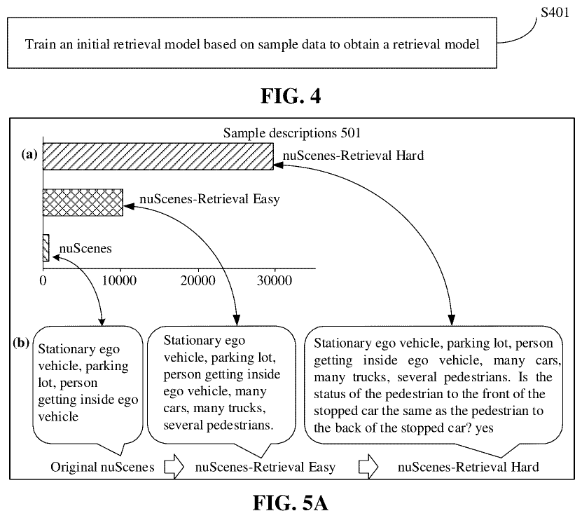

Based on the foregoing embodiment, the embodiments of the present disclosure further provide a method for training a model. FIG. 4 is a schematic flowchart of the method for training a model according to an embodiment of the present disclosure. As illustrated in FIG. 4, the method may include the following operation.

In operation S401, an initial retrieval model is trained based on sample data to obtain a retrieval model.

The retrieval model is used to determine a matching result between the first language feature and a Birds Eyes feature set corresponding to an image set. The first language feature is extracted from the retrieval text. The matching result is used to determine a target image from the image set.

In an embodiment, the sample data includes sample images and sample descriptions. The sample images include panoramic top view images in multiple scenes. The sample descriptions include descriptive data of global features in a three-dimensional space and multiple dimensions for the panoramic top view images in the sample images. A degree of association between the panoramic top view images in the sample images and the descriptive data in the sample descriptions is greater than a degree threshold.

In an embodiment, the panoramic top view images in the sample images may include panoramic top view images of a complex traffic environment in an autonomous driving scene or non-autonomous driving scene. Exemplarily, the panoramic top view images may be BEV images and/or Birds Eyes images.

In an embodiment, the sample descriptions may include data, contextually associated in a temporal dimension and a spatial dimension, and used for describing interrelations between scene objects in multiple scenes. Exemplarily, the above scene objects may include objects such as vehicles, pedestrians, roads, zebra crossings, traffic lights, overpasses, and traffic signs, which is not limited in the embodiments of the present disclosure.

In an embodiment, the descriptive data in the sample descriptions may describe the interrelation between scene objects in multiple scenes at multiple levels and comprehensively.

In an embodiment, the correspondence relations between the panoramic top view images in the sample images and the descriptive data in the sample descriptions may be set in advance.

In an embodiment, the retrieval model may be obtained by the following manner.

In a case that the parameters of the first extraction module, the second extraction module and the feature matching module are maintained to be unchanged, a graph text corresponding to the p-th descriptive data in the sample data is determined in combination with the KG, feature extraction is performed on the graph text and the p-th descriptive data in the sample data through the first extraction module to obtain an initial language feature of the p-th descriptive data, feature extraction is performed on the panoramic top view images in the sample data through the second extraction module to obtain initial image features of the sample data. Alignment processing is performed between the initial language feature of the p-th descriptive data and the initial image features of the sample data through the initial feature alignment module to obtain an initial alignment result, then a matching degree between the initial image features of the sample data and the initial language feature is determined through the feature matching module, and the panoramic top view images in the sample data corresponding to at least two initial image features with the highest matching degree are determined as an initial retrieval result. The parameter of the initial feature alignment module is adjusted according to the difference status between the initial retrieval result and the p-th panoramic top view image, so as to obtain a feature alignment module after the first time of adjustment, and the first extraction module, the second extraction module, the feature alignment module after the first time of adjustment, and the feature matching module are determined as the retrieval model after the first time of adjustment. Then, based on a method similar to the above processes, the parameter of the feature alignment module after the first time of adjustment is adjusted until the matching degree between the retrieval result determined by the retrieval model in the training status and the p-th panoramic top view image is greater than or equal to a preset threshold value. In this way, the first extraction module, the second extraction module, the feature alignment module after the m-th time of adjustment and the feature matching module may be determined as the retrieval model. Here, p may be an integer greater than or equal to 1, the p-th panoramic top-view image may include a panoramic top view image corresponding to the p-th descriptive data in the sample data, and the meaning of the graph text may include an object parameter set corresponding to the above p-th descriptive data in the KG.

As can be seen from the above, in the method for determining an image provided by the embodiments of the present disclosure, an initial retrieval model is trained based on sample data to obtain a retrieval model, the retrieval model is used to determine a matching result between the first language feature and a Birds Eyes feature set corresponding to an image set, the first language feature is extracted from the retrieval text, and the matching result is used to determine a target image from the image set. In this way, the efficiency of determining the matching result can be improved, and the flexibility and portability of the process of finally determining the target image through the retrieval text and the image set may be improved.

Based on the foregoing embodiments, in the method for training a model provided by the embodiments of the present disclosure, the initial retrieval model includes the first extraction module, the second extraction module, an initial feature alignment module, and a feature matching module.

Accordingly, the operation of training the initial retrieval model based on the sample data to obtain the retrieval model may be implemented by the following operations.

In operation SG1, feature extraction is performed on at least the sample descriptions through the first extraction module, to obtain the second language feature, and feature extraction is performed on the sample images through the second extraction module to obtain the second Birds Eyes feature.

The sample data includes sample images and sample descriptions. The sample images include image data in multiple scenes. The sample descriptions include descriptive data for Birds Eyes features of the image data in the sample images. A degree of association between image data in the sample images and descriptive data in the sample descriptions is greater than a degree threshold.

In an embodiment, the image data in the sample images may be panoramic top view images, and a degree of association between the panoramic top view images and the descriptive data in the sample descriptions is greater than a degree threshold, which may include there is a strict and unambiguous correspondence relation between the panoramic top view images in the sample images and the descriptive data in the sample descriptions. Exemplarily, the above correspondence relation may include a one-to-one relation, and may also include a one-to-many relation.

In an embodiment, the second language feature may be obtained by performing feature extraction on the sample descriptions and the object parameter set corresponding to the sample descriptions through the first extraction module during any training process for the initial retrieval model. Accordingly, the second Birds Eyes feature may be obtained by performing feature extraction on the panoramic top view images in the sample data through the second extraction module during any training process for the initial retrieval model.

In operation SG2, feature alignment processing is performed between the second language feature and the second Birds Eyes feature through the initial feature alignment module, to obtain the second Birds Eyes feature after the alignment and the second language feature after the alignment.

In operation SG3, a matching degree between the second Birds Eyes feature after the alignment and the second language feature after the alignment is determined through the feature matching module, and the sample images are screened based on the matching degree, to obtain a sample screening result.

In an embodiment, the matching degree may correspond to the matching result in the foregoing embodiment, which may include multiple cosine similarities.

In an embodiment, the sample screening result may include a panoramic top view image obtained by screening the panoramic top view images in the sample images.

In an embodiment, for the initial feature alignment module, if the input language feature input by the initial feature alignment module may be expressed as C={c₁, c₂, . . . , cₖ}, and the input is a BEV feature, i.e., the second Birds Eyes feature B={b₁, b₂, . . . , bₙ}. Accordingly, the degree of matching between cᵢ in the input language feature and bⱼ in the BEV feature may be expressed by a cosine similarity sᵢⱼ=sim(cᵢ, bⱼ), then for cᵢ, the maximum cosine similarity may be expressed by rᵢ=maxⱼ(sᵢⱼ). Accordingly, the set of cosine similarities may be R={r₁, r₂, . . . , rₖ}. In this case, the weight

$${ω}_{i}^{b} = \frac{{e}_{i}^{r}}{\sum {e}^{r}}$$

may be obtained by processing the set of cosine similarities using the softmax function, then the BEV feature aligned by the initial feature alignment module may be

$${B}^{′ =} \{ {b}_{1}^{′} , {b}_{2}^{′} , … , {b}_{n}^{′} \} = \{ {ω}_{1}^{b} {c}_{1} , {ω}_{2}^{b} {c}_{2} , … , {ω}_{k}^{b} {c}_{k} \} ,$$

and accordingly, if T is adopted to represent the second language feature, the second language feature after the feature alignment may be

$${T}^{′} = \{ {ω}_{1}^{t} {c}_{1} , {ω}_{2}^{t} {c}_{2} , … , {ω}_{k}^{t} {c}_{k} \} .$$

Herein, k and n may both be an integer greater than 2.

In this case, the loss of feature alignment processing between the second language feature and the second Birds Eyes feature through the initial feature alignment module may be expressed by Equations (2) to (4).

$${L}_{SCE} = {L}_{c 1}^{t 2 s} + {L}_{c 1}^{s 2 t} \qquad ( 2 )$$

$${L}_{c 1}^{t 2 s} = \frac{1}{N} {\sum }_{i = 1}^{N} - log ( \frac{exp ( sim ( {t}_{i}^{′} , {b}_{i}^{′} ) / τ )}{{\sum }_{j = 1}^{N} exp ( sim ( {t}_{i}^{′} , {b}_{i}^{′} ) / τ )} ) \qquad ( 3 )$$

$${L}_{c 1}^{s 2 t} = \frac{1}{N} {\sum }_{i = 1}^{N} - log ( \frac{exp ( sim ( {b}_{i}^{′} , {c}_{i}^{′} ) / τ )}{{\sum }_{j = 1}^{N} exp ( sim ( {b}_{i}^{′} , {c}_{i}^{′} ) / τ )} ) \qquad ( 4 )$$

Here, Equation (3) is used to represent the contrastive loss between the second language feature and the second Birds Eyes feature, and Equation (4) is used to represent the contrastive loss between the second Birds Eyes feature and the second language feature.

In operation SG4, inverse processing is performed on the sample screening result through a Caption Generation (CG) module, to generate verification descriptions.

In an embodiment, the description generation module may be used to perform image identifying and text generation processing on the sample screening result to generate the verification descriptions. Exemplarily, the CG module may include the Caption Generation Head in FIG. 3C.

In an embodiment, the verification description may include a descriptive text that comprehensively describes the global features carried by the sample screening result.

Exemplarily, the loss of the CG module may be expressed by Equation (5).

$${L}_{CG} = CrossEntropy ( {P}_{l ogits} , T ) \qquad ( 5 )$$

Here, P_{logits} is the logits of the verification description, and T is the second language feature.

In operation SG5, a parameter of the initial feature alignment module is adjusted based on difference status between the verification descriptions and the sample descriptions to obtain the retrieval model.

In an embodiment, the above difference status may be represented by Equation (6).

$$L = {L}_{SCE} + λ {L}_{CG} \qquad ( 6 )$$

Here, λ is used to represent the weight balance coefficient.

As can be seen from the above, in the method for determining an image provided by the embodiments of the present disclosure, feature extraction is performed on at least the sample descriptions through the first feature extraction module to obtain the second language feature, feature extraction is performed on the sample images through the second extraction module to obtain the second Birds Eyes feature, alignment processing is performed between the second language feature and the second Birds Eyes feature through the initial feature alignment module to obtain the second Birds Eyes feature after the alignment and the second language feature after the alignment, a matching degree between the second Birds Eyes feature after the alignment and the second language feature after the alignment is determined through the feature matching module, and the sample images are screened based on the matching degree to obtain a sample screening result, inverse processing is performed on the sample screening result through the CG module to generate verification descriptions, and finally, a parameter of the initial feature alignment module is adjusted based on difference status between the verification descriptions and the sample descriptions to obtain the retrieval model. The sample data includes sample images and the sample descriptions The sample images include image data in multiple scenes, the sample descriptions include descriptive data for Birds Eyes features of image data in the sample images, and a degree of association between the image data in the sample images and the descriptive data in the sample descriptions is greater than a degree threshold. In this way, the generalization of the retrieval model can be enhanced by the breadth of the sample images included in the sample data, and the accuracy of tracking the second language feature and the second Birds Eyes feature through the retrieval model can be enhanced by the degree of association between the image data and the sample description being greater than the degree threshold. Moreover, by introducing a sample generation module to generate verification descriptions, a closed loop between the verification descriptions and the sample descriptions is realized, thereby realizing closed-loop adjustment and training of the parameter of the initial feature alignment module in the retrieval model, which can improve the ability of the feature alignment module to align language features and image features, and also improve the scene generalization ability and common sense reasoning ability of the retrieval model, so that the retrieval model can more efficiently and accurately retrieve panoramic top-view images in autonomous driving scene.

Based on the foregoing embodiment, in the method for determining an image provided by the embodiments of the present disclosure, the following operations may be further performed before training the initial retrieval model based on the sample data to obtain the retrieval model.

In operation SI1, initial samples are obtained.

The initial samples include initial images and initial texts. The initial images include two-dimensional images. The initial texts include descriptive data for discrete features of the initial images. A degree of association between the initial images and the initial texts is less than a degree threshold.

In an embodiment, the initial samples may include a nuScenes dataset. The initial texts in nuScenes lacks detailed scene information, and the nuScenes dataset includes more than 30,000 samples, but it includes only 848 different text sentences, which leads to significant duplication between the text descriptions included in the nuScenes dataset.

In an embodiment, the discrete features may include fragmented and local descriptions of partial features carried by the initial images.

In an embodiment, the degree of association between the initial images and the initial texts is less than the degree threshold, which may include that an explicit correspondence relation has not been established between the initial images and the initial texts, or there is a repetitive correspondence relation between the initial images and the initial texts.

In operation SI2, scene features carried by the initial images are identified to obtain additional texts.

In an embodiment, the scene features may include features, carried in the initial images, corresponding to the scene corresponding to the initial images. Exemplarily, in a case that the scene corresponding to the initial images is a traffic scene, the scene features may include features of the traffic scene. For example, the above scene features may include a traffic congestion feature, a high-speed road condition feature, and the like.

In an embodiment, feature extraction and identifying may be performed on the initial images through the image feature extraction module, to obtain scene features.

In an embodiment, the additional texts may include descriptive text for scene features.

In an embodiment, the additional texts may be obtained by the following operations.

Context fusion is performed on the features in the scene features to obtain the feature fusion result, and then additional texts are generated based on the feature fusion result.

In operation SI3, the sample descriptions are determined based on the additional texts and the initial texts.

In an embodiment, the sample descriptions may include comprehensive and fine-grained descriptions for the global features carried by the initial images.

In an embodiment, the additional texts and the initial texts may be contextually integrated to obtain sample descriptions. Exemplarily, the sample descriptions may be obtained by expansion augmentation processing for the initial texts based on the additional texts.

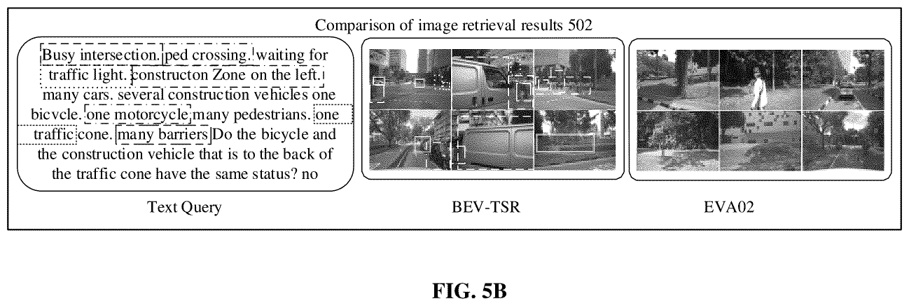

FIG. 5A is a schematic diagram of comparison of effects of sample descriptions at different levels according to an embodiment of the present disclosure. As illustrated in FIG. 5A, the initial samples may correspond to Original nuScenes, the data amount thereof may be the first data amount, and the scene features carried by the initial samples may be relatively scattered.

Exemplarily, by extracting obstacle information from the initial images, quantifying the occurrence frequency of the obstacles, and quantifying the occurrence times of the obstacles, the first additional text is obtained, and then the first additional text and the initial text are expanded and augmented to obtain the first sample description at the nuScenes-Retrieval Easy level, and the data amount of the first sample description may be the second data amount greater than the first data amount, and the scattering degree of scene features carried by the first sample description is reduced. Exemplarily, the first additional text may be “many cars, several trucks, one bus”. Accordingly, sample data corresponding to the first sample description and corresponding to the panoramic top view image corresponding to the first sample description may be recorded as the first sample set.

For example, feature identifying and feature extracting are performed on the initial images by methods such as object detection, scene classification, self-vehicle decision and decision reasoning to obtain the second additional text, and then the first sample description at the nuScenes-Retrieval Easy level is further expanded and augmented based on the second additional text to obtain the second sample description at the nuScenes-Retrieval Hard level. The data amount of the second sample description may be the third data amount greater than the second data amount, and the scattering degree of the scene features carried by the second sample description is further reduced. The first data amount may be less than 5,000, the second data amount may be about 10,000, and the third data amount may be about 30,000. Accordingly, sample data corresponding to the second sample description and corresponding to the panoramic top view images corresponding to the second sample description may be recorded as the second sample set.

In operation SI4, global feature integration is performed on the initial images to obtain sample images.

In an embodiment, the sample images may be obtained by the following manner.

BEV encoding is performed on the image features of the initial images through the BEV encoder, so as to obtain the sample images represented by the panoramic top view image.

In operation SI5, the sample descriptions are correlated with the sample images to obtain sample data.

A degree of association between the image data in the sample images and the descriptive data in the sample descriptions is greater than a degree threshold.

TABLE 1

| Retrieval Method | Retrieve Space | Text Retrieval | Image Retrieval result |
|---|---|---|---|
| SigLIP-Base | Front View | 0.3863 0.7640 0.8613 | 0.3924 0.7863 0.8698 |
| | Surrounding View | 0.3433 0.7625 0.8593 | 0.3597 0.7740 0.8672 |
| CLIP-ViT-Base | Front View | 0.4377 0.8610 0.9569 | 0.4421 0.9003 0.9795 |
| | Surrounding View | 0.4846 0.9085 0.9815 | 0.4644 0.9258 0.9845 |
| EVA02-Base | Front View | 0.4919 0.7306 0.7977 | 0.5585 0.7807 0.844 |
| | Surrounding View | 0.4369 0.7153 0.7986 | 0.5181 0.7896 0.8637 |
| BEV-TSR | BEV Space | 0.8578 0.9954 0.9994 | 0.8766 0.9971 0.9997 |

It should be noted that, in a case that the sample descriptions included in the sample data are the first sample description and the second sample description, respectively, the retrieval performance, for the image set based on the retrieval text, of the retrieval model trained on the basis of different sample data may be different.

Table 1 shows the statistical results of the retrieval ability of the retrieval model trained based on the first sample set.

Table 2 shows the statistical results of the retrieval ability of the retrieval model trained based on the second sample set.

TABLE 2

| Retrieval Method | Retrieve Space | Text Retrieval | Image Retrieval result |
|---|---|---|---|
| SigLIP-Base | Front View | 0.2687 0.6573 0.76610.2 | 0.2850 0.6691 0.7670 |
| | Surrounding View | 594 0.6487 0.7379 | 0.2843 0.6501 0.7365 |
| CLIP-ViT-Base | Front View | 0.2829 0.6501 0.78860.2 | 0.2986 0.6888 0.7863 |
| | Surrounding View | 904 0.6619 0.7953 | 0.3163 0.7066 0.7896 |
| EVA02-Base | Front View | 0.2908 0.6763 0.78600.2 | 0.3064 0.6980 0.7936 |
| | Surrounding View | 774 0.6395 0.7318 | 0.2965 0.6538 0.7430 |
| BEV-TSR | BEV Space | 0.6608 0.9912 0.9997 | 0.6790 0.9862 0.9991 |

In Table 1 and Table 2, the retrieval results of other methods for determining an image including CLIP-ViT-Base, SigLIP-Base, and EVA02-Base based on six surrounding images (front view and surrounding view) are compared with the retrieval result of BEV-TSR based on BEV space, as can be seen from Table 1 and Table 2, compared with other methods for determining an image, the performance of BEV-TSR trained based on different sample data in retrieving the image has been improved (85.78% and 87.66% being top-1 accuracy). Compared with the BEV-TSR trained by the nuScenes-Retrieval Easy dataset, the performance of the BEV-TSR corresponding to the nuScenes-Retrieval Hard dataset has decreased, but it is still superior to other methods for determining an image in most indicators. The above data shows that BEV-TSR is better than other methods shown in the table in processing complex scenes and understanding complex text queries, and can accurately understand the context information contained in the text, thus enabling it to retrieve BEV images in complex traffic scenes.

It should be noted that, in the technical solutions provided by the embodiments of the present disclosure, not only the BEV image can be retrieved based on the retrieval text, but also the two-dimensional image can be retrieved based on the retrieval text. FIG. 5B is a schematic diagram of comparison of effects of retrieving two-dimensional images according to an embodiment of the present disclosure. As illustrated in FIG. 5B, when the input text (Text Query) is the same, the first image set shown in the middle of FIG. 5B in multiple traffic scenes corresponding to the Text Query can be obtained through the BEV-TSR provided by the embodiment of the present disclosure, and the image set obtained by the EVA02 based on the above Text Query is the second image set shown in the right side of FIG. 5B. It can be seen from the first image set and the second image set that the pixel features included in the first image set match the scenes represented by the Text Query, and the pixel features are contextually associated in the spatial dimension, while the features carried by the second image set have high dispersion and poor contextual correlation.

As can be seen from the above, in the method for training an model provided by the embodiments of the present disclosure, initial samples and initial texts are obtained, the initial texts include descriptive data for discrete features of the initial images, the degree of association between the initial images and the initial texts is less than a degree threshold, and the initial images include two-dimensional images. Then scene features and object features carried by the initial images are identified to obtain additional texts, and after obtaining the additional texts, sample descriptions are obtained based on the additional texts and the initial texts. In this way, the expansion and augmentation of the initial text in the scene features and object feature dimensions in the initial samples have been achieved through the above operations, thereby improving the comprehensiveness and accuracy of the data in the sample description. Further, global feature integration is performed on the initial images to obtain sample images, so that the comprehensiveness and diversity of features in the sample images can be improved through the above operation. On this basis, the sample descriptions and the sample images are correlated to obtain sample data, and the degree of association between the image data in the sample images and the descriptive data in the sample descriptions is greater than a degree threshold, so that the association between the sample descriptions and the sample images in the sample data is enhanced.

In order to separately evaluate the role played by respective modules in the retrieval model in the process of image retrieval, embodiments of the present disclosure also provide module ablation results for the retrieval model.

In the embodiment of the present disclosure, the feature alignment module may be implemented to be a SCE, and achieves remarkable improvements of 5.73% scene retrieval by aligning the BEV and the text modalities within a unified embedding space. For example, if a Multilayer Perceptron (MLP) layer is used to map image features and text features, BEV image retrieval for complex autonomous driving scenes can still be realized while the KG and CG module remain unchanged.

In the embodiment of the present disclosure, for the first extraction module, in addition to the combination of LoRA and fine-tuning Llama2 in the foregoing embodiment, a Bidirectional Encoder Representations from Transformers (BERT) may be used instead of the combination of LoRA and fine-tuning Llama2. The Llama2 may be applied to pre-training tasks including fewer traffic scenes, and fine-tuning makes the model adapt the specific context of autonomous driving scene.

In an embodiment of the present disclosure, the second extraction module may include a BEV encoder. Exemplarily, a BEV Det or a BEV Former may be used instead of the BEV encoder, and experiments have shown that the above three encoders can accurately convert features of the two-dimensional image into the BEV space.

Table 3 shows the first statistical results of ablation comparison of combinations of different modules provided by embodiments of the present disclosure.

TABLE 3

| | | | | Text Retrieval | | Scene Retireval | |
|---|---|---|---|---|---|---|---|
| BEV | SCE | KGP | CG | R@1 | R@5 | R@1 | R@5 |
| x | x | x | x | 0.4846 | 0.9085 | 0.4644 | 0.9258 |
| [symbol] | x | x | x | 0.7875 | 0.9757 | 0.8194 | 0.9812 |
| x | [symbol] | x | x | 0.8352 | 0.9944 | 0.8431 | 0.9962 |
| x | x | [symbol] | x | 0.8469 | 0.9947 | 0.8557 | 0.9968 |
| x | x | x | [symbol] | 0.8578 | 0.9954 | 0.8766 | 0.9971 |

Table 4 shows the second statistical results of ablation comparison of combinations of different modules provided by the embodiments of the present disclosure.

TABLE 4

| | |
|---|---|
| Text Retrieval | Scene Retireval |

| | | | | |
|---|---|---|---|---|
| Module | R@1 | R@5 | R@1 | R@5 |

BEV Encoder

| | | | | |
|---|---|---|---|---|
| BEVDet | 0.7955 | 0.9929 | 0.8021 | 0.9917 |
| BEVFormer | 0.8578 | 0.9954 | 0.8766 | 0.9971 |

Text Encoder

| | | | | |
|---|---|---|---|---|
| BERT | 0.6409 | 0.9129 | 0.5594 | 0.8915 |
| Llama2 | 0.7244 | 0.9472 | 0.7030 | 0.9507 |
| LoRA | 0.7875 | 0.9757 | 0.8194 | 0.9812 |

Knowledge Graph Prompting

| | | | | |
|---|---|---|---|---|
| TransE | 0.8487 | 0.9914 | 0.8559 | 0.9914 |
| ConvE | 0.8501 | 0.9928 | 0.8602 | 0.9956 |
| Distmult | 0.8578 | 0.9954 | 0.8766 | 0.9971 |

Shared Cross-modal Embedding

| | | | | |
|---|---|---|---|---|
| k = 1024 | 0.8487 | 0.9912 | 0.8602 | 0.9971 |
| k = 2048 | 0.8473 | 0.9937 | 0.8689 | 0.9968 |
| k = 4096 | 0.8578 | 0.9954 | 0.8766 | 0.9971 |

Specific instructions are as follows.

Compared with BEVDet, BEVFormer has achieved better performance in both text and scene retrieval tasks, which indicates that BEVFormer is more effective in transforming 2D features into 3D space. The retrieval performance of the Llama2 model fine-tuned using LoRA on text and scene retrieval tasks is better than that of BERT and unfine-tuned Llama2 models, which indicates the importance of fine-tuning to improve model performance. DistMult performs best in KG embedding and is therefore selected as the default KG embedding extractor. For the SCE, as the embedding vector dimension increases, the model performance improves, and the best performance can be obtained when the vector dimension reaches 4096. Therefore, a larger embedding space helps to better align the features of different modes.

In summary, the retrieval model provided by the embodiment of the present disclosure is a novel BEV-TSR framework, which can realize BEV image retrieval for a retrieval text received in an autonomous driving scene within BEV images. In the above retrieval process, the global context of the retrieval text can be fully understood, so that the BEV corresponding to the complex traffic scene can be retrieved. In the above process, when processing the retrieval text, through the combination of LLM and KG, an accurate and in-depth understanding of all aspects of the retrieved text can be achieved, so that the first language feature can have high-level rich semantics. In the above process, the gap between BEV features and language embeddings is bridged by introducing shared learnable embeddings in Shared cross-modal embeddings, thereby improving the accuracy of subsequent feature matching.

Moreover, in the process of training BEV-TSR, the alignment may be further enhanced in combination with the CG model. At the same time, during the training process, with the help of the multi-level retrieval data set nuScenes-Retrieval based on the nuScenes data set, BEV-TSR can achieve more accurate and efficient BEV image retrieval.

Based on the foregoing embodiments, the embodiments of the present disclosure further provide an apparatus for determining an image. FIG. 6 is a schematic structural diagram of the apparatus for determining an image according to the embodiment of the present disclosure. As illustrated in FIG. 6, the apparatus for determining an image 600 includes a processing module 601 and a determining module 602.

The processing module 601 is configured to extract the first language feature from a retrieval text.

The determining module 602 is configured to determine a matching result between the first language feature and a Birds Eyes feature set corresponding to an image set, and determine a target image from the image set based on the matching result.

In some embodiments, the processing module 601 is configured to perform feature extraction processing on the retrieval text to obtain the first text feature.

The processing module 601 is configured to determine the second text feature corresponding to the target scene based on a KG, and integrate the first text feature and the second text feature to obtain the first language feature. The KG is associated with at least the target scene.

In some embodiments, the processing module 601 is configured to analyze the target scene based on the KG to determine an object parameter set, and perform feature extraction processing on a parameter in the object parameter set to obtain the second text feature. The object parameter set includes a status parameter of at least one scene object in the target scene.

In some embodiments, the processing module 601 is configured to perform feature extraction processing on an image in the image set to obtain the first Birds Eyes feature, perform alignment processing between the first Birds Eyes feature and the first language feature, and match the first Birds Eyes feature after the alignment and the first language feature after the alignment to obtain the matching result. The Birds Eyes feature set includes the first Birds Eyes feature.

In some embodiments, the determining module 602 is configured to process the first language feature and the Birds Eyes feature set through at least a part of modules in a retrieval model, to determine the matching result. The retrieval model includes the first extraction module, the second extraction module, a feature alignment module, and a feature matching module. The first extraction module is configured to process the retrieval text to obtain the first language feature, the second extraction module is configured to perform feature extraction on an image in the image set to obtain the first Birds Eyes feature, the feature alignment module is configured to align the first Birds Eyes feature and the first language feature, and the feature matching module is configured to match the first Birds Eyes feature after the alignment and the first language feature after the alignment to obtain the matching result.

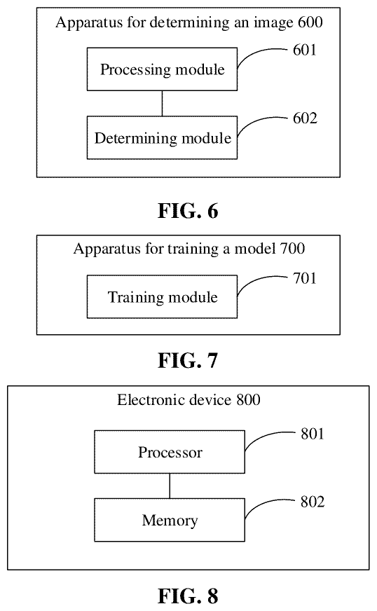

Based on the foregoing embodiments, the embodiments of the present disclosure further provide an apparatus for training a model. FIG. 7 is a schematic structural diagram of the apparatus for training a model according to an embodiment of the present disclosure. As illustrated in FIG. 7, the apparatus for training a model 700 may include a training module 701.

The training module 701 is configured to train an initial retrieval model based on sample data to obtain a retrieval model. The retrieval model is used to determine a matching result between the first language feature and a Birds Eyes feature set corresponding to an image set, the first language feature is extracted from the retrieval text, and the matching result is used to determine a target image from the image set.

In some embodiments, the initial retrieval model includes the first extraction module, the second extraction module, an initial feature alignment module, and a feature matching module.

The training module 701 is configured to perform feature extraction on sample descriptions through the first extraction module to obtain the second language feature, perform feature extraction on the sample images through the second extraction module to obtain the second Birds Eyes feature, perform alignment processing between the second language feature and the second Birds Eyes feature through the initial feature alignment module to obtain the second Birds Eyes feature after the alignment and the second language feature after the alignment, determine a matching degree between the second Birds Eyes feature after the alignment and the second language feature after the alignment through the feature matching module, and screen the sample images based on the matching degree to obtain a sample screening result, perform inverse processing on the sample screening result through the CG module to generate verification descriptions, and adjust a parameter of the initial feature alignment module based on difference status between the verification descriptions and the sample descriptions to obtain the retrieval model. The sample data includes sample images and sample descriptions. The sample images include image data in multiple scenes. The sample descriptions include descriptive data for Birds Eyes features of images in the sample images. A degree of association between the images in the sample images and the descriptive data in the sample descriptions is greater than a degree threshold.

In some embodiments, the training module 701 is configured to obtain initial samples. The initial samples include initial images and initial texts. The initial images include two-dimensional images. The initial texts include descriptive data for discrete features of the initial images. A degree of association between the initial images in the initial samples and the initial texts in the initial samples is less than a degree threshold.

The training module 701 is further configured to identify scene features carried by the initial images to obtain additional texts, determine the sample descriptions based on the additional texts and the initial texts, perform global feature integration on the initial images to obtain sample images, and correlate the sample descriptions with the sample images to obtain sample data. A degree of association between the image data in the sample images and the descriptive data in the sample descriptions is greater than a degree threshold.

Based on the foregoing embodiments, the embodiments of the present disclosure further provide an electronic device. FIG. 8 is a schematic structural diagram of the electronic device according to an embodiment of the present disclosure. As illustrated in FIG. 8, the electronic device 800 includes a processor 801 and a memory 802. A computer program is stored in the memory 802. When the computer program is executed by the processor 801, the above method for determining an image or a method for training a model is implemented.

Based on the foregoing embodiments, the embodiments of the present disclosure further provide a computer readable storage medium. A computer program is stored in the storage medium. When the computer program is executed by the processor of the electronic device, the above method for determining an image or a method for training a model is implemented.

Based on the foregoing embodiments, the embodiments of the present disclosure further provide a computer program product. The program product includes a computer program. When the computer program is executed by the processor of the electronic device, the above method for determining an image or a method for training a model is implemented.

In some embodiments, the computer readable storage medium may be a Read-Only Memory (ROM), a Programmable read-only memory (PROM), an Erasable Programmable Read Only Memory (EPROM), an Electrically Erasable Programmable read only memory (EEPROM), a flash memory, a magnetic surface memory, an optical disc, or a Compact Disc Read-Only Memory (CD-ROM). It may also be various devices including one or any combination of the memories described above.

In some embodiments, the computer executable instructions may take the form of programs, software, software modules, scripts, or code, are written in any form of programming language, including compiled or interpreted languages, or declarative or procedural languages, and may be deployed in any form, including as standalone programs or as modules, components, subroutines, or other units suitable for use in a computing environment.

By way of example, computer executable instructions may, but do not necessarily correspond to files in a file system, may be stored as part of a file holding other programs or data, for example, stored in one or more scripts in a Hyper Text Markup Language (HTML) document, stored in a single file dedicated to the program in discussion, or, stored in multiple co-files (for example, files storing one or more modules, subprogram, or code portions).

1. A method for determining an image, comprising:
extracting a first language feature from a retrieval text;
determining a matching result between the first language feature and a Birds Eyes feature set corresponding to an image set; and
determining a target image from the image set based on the matching result.

2. The method of claim 1, wherein extracting the first language feature from the retrieval text comprises:
performing feature extraction processing on the retrieval text to obtain a first text feature, wherein the retrieval text comprises descriptive data for a plurality of dimensions of a target scene;
determining, based on a Knowledge Graph (KG), a second text feature corresponding to the target scene, wherein the KG is associated with at least the target scene; and
integrating the first text feature and the second text feature to obtain the first language feature.

3. The method of claim 2, wherein determining, based on the KG, the second text feature corresponding to the target scene comprises:
analyzing the target scene based on the KG to determine an object parameter set, wherein the object parameter set comprises a status parameter of at least one scene object in the target scene; and
performing feature extraction processing on a parameter in the object parameter set to obtain the second text feature.

4. The method of claim 1, wherein determining the matching result between the first language feature and the Birds Eyes feature set corresponding to the image set comprises:
performing feature extraction processing on an image in the image set to obtain a first Birds Eyes feature, wherein the Birds Eyes feature set comprises the first Birds Eyes feature;
performing alignment processing between the first Birds Eyes feature and the first language feature; and
matching the first Birds Eyes feature after the alignment and the first language feature after the alignment to obtain the matching result.

5. The method of claim 1, wherein determining the matching result between the first language feature and the Birds Eyes feature set corresponding to the image set comprises:
processing the first language feature and the Birds Eyes feature set through at least a part of modules in a retrieval model, to determine the matching result, wherein the retrieval model comprises a first extraction module, a second extraction module, a feature alignment module, and a feature matching module, the first extraction module is configured to process the retrieval text to obtain the first language feature, the second extraction module is configured to perform feature extraction on an image in the image set to obtain a first Birds Eyes feature, the feature alignment module is configured to align the first Birds Eyes feature and the first language feature, the feature matching module is configured to match the first Birds Eyes feature after the alignment and the first language feature after the alignment to obtain the matching result, and the Birds Eyes feature set comprises the first Birds Eyes feature.

6. A method for training a model, comprising:
training an initial retrieval model based on sample data to obtain a retrieval model, wherein the retrieval model is used to determine a matching result between a first language feature and a Birds Eyes feature set corresponding to an image set, the first language feature is extracted from retrieval text, and the matching result is used to determine a target image from the image set.

7. The method of claim 6, wherein the initial retrieval model comprises a first extraction module, a second extraction module, an initial feature alignment module, and a feature matching module, and training the initial retrieval model based on the sample data to obtain the retrieval model comprises:
performing feature extraction on sample descriptions through the first extraction module, to obtain a second language feature, wherein the sample data comprises sample images and the sample descriptions, the sample images comprise image data in a plurality of scenes, the sample descriptions comprise descriptive data for Birds Eyes features of image data in the sample images, a degree of association between the image data in the sample images and descriptive data in the sample descriptions is greater than a degree threshold;
performing feature extraction on the sample images through the second extraction module to obtain a second Birds Eyes feature;
performing alignment processing between the second language feature and the second Birds Eyes feature through the initial feature alignment module, to obtain the second Birds Eyes feature after the alignment and the second language feature after the alignment;
determining a matching degree between the second Birds Eyes feature after the alignment and the second language feature after the alignment through the feature matching module, and screening the sample images based on the matching degree, to obtain a sample screening result;
performing inverse processing on the sample screening result through a Caption Generation (CG) module, to generate verification descriptions; and
adjusting a parameter of the initial feature alignment module based on difference status between the verification descriptions and the sample descriptions, to obtain the retrieval model.

8. The method of claim 6, wherein before training the initial retrieval model based on the sample data to obtain the retrieval model, the method further comprises:
obtaining initial samples, wherein the initial samples comprise initial images and initial texts, the initial images comprise two-dimensional images, the initial texts comprise descriptive data for discrete features of the initial images, and a degree of association between the initial images and the initial texts is less than a degree threshold;
identifying scene features carried by the initial images to obtain additional texts;
determining sample descriptions based on the additional texts and the initial texts;
performing global feature integration on the initial images to obtain sample images; and
correlating the sample descriptions with the sample images to obtain the sample data, wherein a degree of association between image data in the sample images and descriptive data in the sample descriptions is greater than a degree threshold.

9. An apparatus for determining an image, comprising a processor and a memory, wherein the memory is configured to store a computer program that, when being executed by the processor, causes the apparatus to:
extract a first language feature from a retrieval text; and
determine a matching result between the first language feature and a Birds Eyes feature set corresponding to an image set, and determine a target image from the image set based on the matching result.

10. The apparatus of claim 9, wherein when extracting the first language feature from the retrieval text, the processor is configured to causes the apparatus to:
perform feature extraction processing on the retrieval text to obtain a first text feature, wherein the retrieval text comprises descriptive data for a plurality of dimensions of a target scene;
determine, based on a Knowledge Graph (KG), a second text feature corresponding to the target scene, wherein the KG is associated with at least the target scene; and
integrate the first text feature and the second text feature to obtain the first language feature.

11. The apparatus of claim 10, wherein when determining, based on the KG, the second text feature corresponding to the target scene, the processor is configured to causes the apparatus to:
analyze the target scene based on the KG to determine an object parameter set, wherein the object parameter set comprises a status parameter of at least one scene object in the target scene; and
perform feature extraction processing on a parameter in the object parameter set to obtain the second text feature.

12. The apparatus of claim 9, wherein when determining the matching result between the first language feature and the Birds Eyes feature set corresponding to the image set, the processor is configured to causes the apparatus to:
perform feature extraction processing on an image in the image set to obtain a first Birds Eyes feature, wherein the Birds Eyes feature set comprises the first Birds Eyes feature;
perform alignment processing between the first Birds Eyes feature and the first language feature; and
match the first Birds Eyes feature after the alignment and the first language feature after the alignment to obtain the matching result.

13. The apparatus of claim 9, wherein when determining the matching result between the first language feature and the Birds Eyes feature set corresponding to the image set, the processor is configured to causes the apparatus to:
process the first language feature and the Birds Eyes feature set through at least a part of modules in a retrieval model, to determine the matching result, wherein the retrieval model comprises a first extraction module, a second extraction module, a feature alignment module, and a feature matching module, the first extraction module is configured to process the retrieval text to obtain the first language feature, the second extraction module is configured to perform feature extraction on an image in the image set to obtain a first Birds Eyes feature, the feature alignment module is configured to align the first Birds Eyes feature and the first language feature, the feature matching module is configured to match the first Birds Eyes feature after the alignment and the first language feature after the alignment to obtain the matching result, and the Birds Eyes feature set comprises the first Birds Eyes feature.

14. An apparatus for training a model, comprising a processor and a memory, wherein the memory is configured to store a computer program that, when being executed by the processor, causes the apparatus to perform the method for training a model of claim 6, the method comprising:
training an initial retrieval model based on sample data to obtain a retrieval model, wherein the retrieval model is used to determine a matching result between a first language feature and a Birds Eyes feature set corresponding to an image set, the first language feature is extracted from the retrieval text, and the matching result is used to determine a target image from the image set.

15. The apparatus of claim 14, wherein the initial retrieval model comprises a first extraction module, a second extraction module, an initial feature alignment module, and a feature matching module, and when training the initial retrieval model based on the sample data to obtain the retrieval model, the processor is configured to causes the apparatus to:
perform feature extraction on sample descriptions through the first extraction module, to obtain a second language feature, wherein the sample data comprises sample images and the sample descriptions, the sample images comprise image data in a plurality of scenes, the sample descriptions comprise descriptive data for Birds Eyes features of image data in the sample images, a degree of association between the image data in the sample images and descriptive data in the sample descriptions is greater than a degree threshold;
perform feature extraction on the sample images through the second extraction module to obtain a second Birds Eyes feature;
perform alignment processing between the second language feature and the second Birds Eyes feature through the initial feature alignment module, to obtain the second Birds Eyes feature after the alignment and the second language feature after the alignment;
determine a matching degree between the second Birds Eyes feature after the alignment and the second language feature after the alignment through the feature matching module, and screen the sample images based on the matching degree, to obtain a sample screening result;
perform inverse processing on the sample screening result through a Caption Generation (CG) module, to generate verification descriptions; and
adjust a parameter of the initial feature alignment module based on difference status between the verification descriptions and the sample descriptions, to obtain the retrieval model.

16. The apparatus of claim 14, wherein before training the initial retrieval model based on the sample data to obtain the retrieval model, the processor is further configured to causes the apparatus to:
obtain initial samples, wherein the initial samples comprise initial images and initial texts, the initial images comprise two-dimensional images, the initial texts comprise descriptive data for discrete features of the initial images, and a degree of association between the initial images and the initial texts is less than a degree threshold;
identify scene features carried by the initial images to obtain additional texts;
determine sample descriptions based on the additional texts and the initial texts;
perform global feature integration on the initial images to obtain sample images; and
correlate the sample descriptions with the sample images to obtain the sample data, wherein a degree of association between image data in the sample images and descriptive data in the sample descriptions is greater than a degree threshold.

17. A non-transitory computer-readable storage medium, having a computer program stored therein, wherein when the computer program is executed by a processor of an electronic device, the method for determining an image of claim 1 is implemented.

18. A non-transitory computer-readable storage medium, having a computer program stored therein, wherein when the computer program is executed by a processor of an electronic device, the method for training a model of claim 6 is implemented.

19. A computer program product, comprising a computer program, wherein when the computer program is executed by a processor of an electronic device, the method for determining an image of claim 1 is implemented.

20. A computer program product, comprising a computer program, wherein when the computer program is executed by a processor of an electronic device, the method for training a model of claim 6 is implemented.
